(19) United States
(12) Patent Application Publication
(10) Pub. No.: US 2021/0406785 A1
(43) Pub. Date: Dec. 30, 2021

(54) COMPUTER-IMPLEMENTED SYSTEMS AND METHODS FOR PREPARING COMPLIANCE DOCUMENTATION

(71) Applicant: Bobcat Cyber LLC, Phoenix, AZ (US)

(72) Inventor: Michael Wojcik, Phoenix, AZ (US)

(73) Assignee: Bobcat Cyber LLC, Phoenix, AZ (US)

(21) Appl. No.: 17/357,637

(22) Filed: Jun. 24, 2021

Related U.S. Application Data
(60) Provisional application No. 62/705,374, filed on Jun. 24, 2020.

(51) Int. Cl. G06Q 10/06; G06Q 10/10; G06F 16/23

(52) U.S. Cl. CPC G06Q 10/067; G06F 16/2365; G06Q 10/10

(57) ABSTRACT

The system uses an interview approach to the accreditation process implemented on a computer system. The interview involves systematic “walk-through” interview screens that are unique to a particular accreditation process and/or maturity level of accreditation. The model framework in one embodiment organizes the processes and practices of an accreditation standard into a set of domains and maps them across accreditation maturity levels. In order to provide additional structure, the framework also aligns the practices to a set of capabilities within each domain. An embodiment provides a structured interview approach including recommended responses and “help screens.” The responses to the interview process are close ended, matching the requirements of the standard, allowing easier understanding and completion of the process. It also generates documentation required for accreditation, including processes and practices tailored to the individual company.

This patent application claims priority to U.S. Provisional Patent Application 62/705,374 filed on Jun. 24, 2020, which is incorporated by reference herein in its entirety.

### BACKGROUND OF THE SYSTEM

Computers and computer networks are subject to attacks through malware, ransomware, hacking, unauthorized access and the like, often referred to as “cyber threats”. Malicious cyber actors have targeted and continue to target companies, educational institutions, and government agencies. The aggregate loss of intellectual property and certain sensitive information can undercut U.S. technical advantages and innovation as well as significantly increased risk to national security and loss of privacy for its citizens.

The process of protecting computing assets from such attacks is known as “cybersecurity”. Government agencies and other organizations have developed regulatory requirements that combine best practices and various cybersecurity standards to improve the strength of the cybersecurity of systems.

As noted above companies will need to various regulatory frameworks to become compliant for handling sensitive data. A problem with current efforts to obtain compliance and/or certification is that the standards are constantly evolving, there is extensive paperwork and the process can be confusing and time consuming. Often an entity might use different terminology and incorrectly provide data that can lead to a lower security level and failure to meet qualifying compliance levels.

There are a number of compliance, certification, and accreditation processes that suffer from the same disadvantages.

### SUMMARY

The system uses an interview approach to the compliance process implemented on a computer system. The interview involves systematic “walk-through” interview screens that are unique to a particular compliance standard process and/or maturity level of accreditation. The model framework in one embodiment organizes the processes and practices of a regulatory standard into a set of domains and maps them across security levels. In order to provide additional structure, the framework also aligns the practices to a set of capabilities within each domain. An embodiment provides a structured interview approach including recommended responses and “help screens.” The responses to the interview process are close ended, matching the requirements of the standard, allowing easier understanding and completion of the process. It also generates documentation required for accreditation and compliance, based on user responses, including processes and practices tailored to the individual company. Embodiments are also related to providing explanations regarding the accreditation questions (e.g., information to assist the user to determine whether a certain response should be selected to meet the desired maturity level). Embodiments are also related to providing statistics and analytics relating to how peer organizations responded in order to help the user choose industry standard security practices and thereby demonstrate compliance.

### BRIEF DESCRIPTION OF THE DRAWINGS

FIG. 1 illustrates a first example interview screen in an embodiment of the system.

FIG. 2 illustrates a second example interview screen in an embodiment of the system.

FIG. 3 is a block diagram of an embodiment of the system for receiving inputs.

FIG. 4 is a block diagram of an embodiment of the system for generating outputs.

FIG. 5 is a flow diagram illustrating the operation of the system in one embodiment.

FIG. 6 is a flow diagram illustrating use of a completeness graph in an embodiment of the system.

FIG. 7 is an example computer embodiment of the system.

FIG. 8 is a block diagram of an embodiment of the system for generating questions.

FIG. 9 is an example of presenting peer data to a user in an embodiment.

### DETAILED DESCRIPTION OF THE SYSTEM

The system is a computer implemented method for preparing regulatory standard documentation using an “interview” approach, using a modified version of the standard maturity requirements modified by the inclusion of interface elements displayed to a user. In one sense, the present system provides an overlay interface to the accreditation requirements that is a more natural method of obtaining information from a user.

The system can be used with any accreditation process, including the Cybersecurity Maturity Model Certification (CMMC), Health Insurance Portability and Accountability Act (HIPAA), PCI-DSS (Payment Card Industry Data Security Standard), California Consumer Privacy Act (CCPA), the European Union General Data Protection Regulation (GDPR), Federal Financial Institutions Examination Council (FFIEC), other regulatory standards, and the like. An embodiment of the system is described in connection with CMMC certification.

By way of example, the CMMC data may include business information, business processes, and company security procedures. In response to the user selecting an interface element, presentation of an explanation regarding a CMMC security requirement or operation for the associated field is invoked. The user interface controller provides data in response to selection of the interface element from a logic engine, which determines a question based at least in part upon the maturity level required. The question and explanation(s) is/are provided to the user interface controller for presentation to the user.

There are five levels of maturity in the CMMC. Depending on the accreditation sought by a company, one of the maturity levels must be present. The maturity levels are described below.

CMMC Level 1

Processes: Performed

Level 1 requires that an organization performs the specified practices. Because the organization may be able to perform these practices only in an ad-hoc manner and may or may not rely on documentation, process maturity is not assessed for Level 1.

Practices: Basic Cyber Hygiene

Level 1 focuses on the protection of FCI and consists only of practices that correspond to the basic safeguarding requirements specified in 48 CFR 52.204-21.

CMMC Level 2

Processes: Documented

Level 2 requires that an organization establish and document practices and policies to guide the implementation of their CMMC efforts. The documentation of practices enables individuals to perform them in a repeatable manner. Organizations develop mature capabilities by documenting their processes and practicing them as documented.

Practices: Intermediate Cyber Hygiene

Level 2 serves as a progression from Level 1 to Level 3 and consists of a subset of the security requirements specified in NIST SP 800-171 as well as practices from other standards and references. Because this level is a transitional stage, a subset of the practices reference the protection of CUI.

CMMC Level 3

Processes: Managed

Level 3 requires that an organization establish, maintain and resource a plan demonstrating the management of activities for practice implementation. The plan may include information on missions, goals, project plans, resourcing, required training, and involvement of relevant stakeholders.

Practices: Good Cyber Hygiene

Level 3 focuses on the protection of CUI and encompasses all of the security requirements specified in NIST SP 800-171 as well as 20 additional practices to mitigate threats. Any contractor with a DFARS clause in their contract will need to at least meet Level 3 requirements.

CMMC Level 4

Processes: Reviewed

Level 4 requires that an organization review and measure practices for effectiveness. In addition, organizations at this level are able to take corrective action when necessary and inform higher level management of status or issues on a recurring basis.

Practices: Proactive

Level 4 focuses on the protection of CUI from APTs and encompasses a subset of the enhanced security requirements from Draft NIST SP 800-171B as well as other cybersecurity best practices. These practices enhance the detection and response capabilities of an organization to address and adapt to the changing tactics, techniques and procedures (TTPs) used by APTs.

CMMC Level 5

Processes: Optimizing

Level 5 requires an organization to standardize and optimize process implementation across the organization.

Practices: Advanced/Proactive

Level 5 focuses on the protection of CUI from APTs. The additional practices increase the depth and sophistication of cybersecurity capabilities.

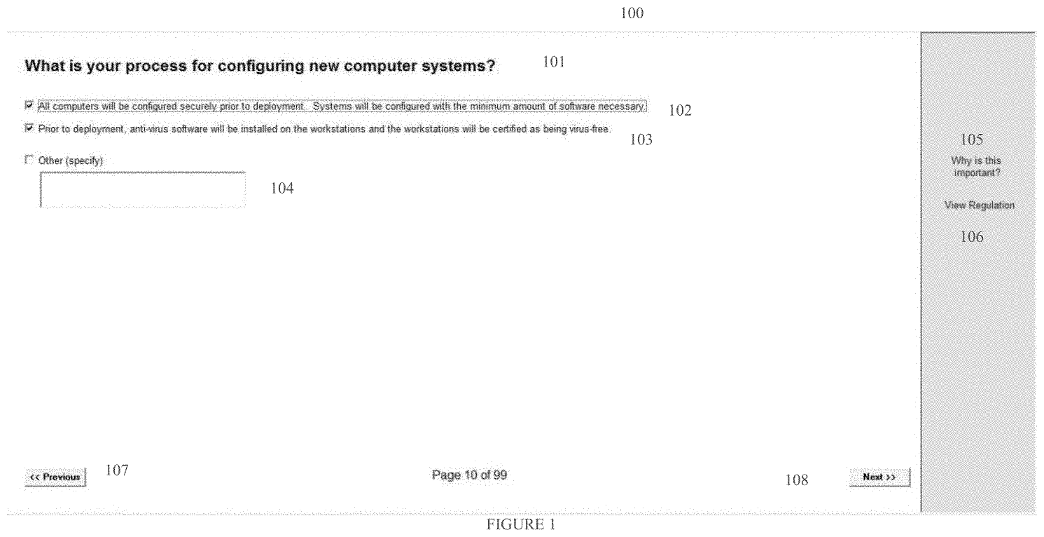

FIG. 1 illustrates a first example interview screen in an embodiment of the system. The interview screen 100 includes a question region 101. The question in region 101 is generated by the system based on the maturity level being sought by the user and is presented in a narrative form that is more natural to the user. The system then provides statements in regions 102 and 103 with associated checkboxes to indicate whether the statement is true for the user. The number of statements will vary depending on the question and the level of maturity being sought.

Region 104 provides a text box where the user can enter free form text to provide additional information or explanation as needed. Regions 105 and 106 provide access to helpful information to the user to assist in completing the questions. For instance, region 105 states “Why is this important?”. Selecting this region links to information about the current question to explain what it means to the level of maturity associated with the current question. In one embodiment, this may also result in the system providing peer group information regarding possible answers. For example, the system may show a graph or chart showing the percentage of similarly situated users or organizations who selected each possible answer on an interview screen.

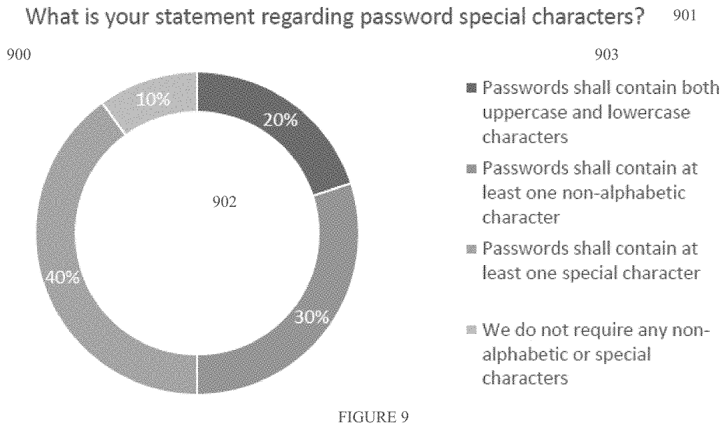

An example of peer data presentation in an embodiment is illustrated in FIG. 9. The graph 900 is provided when the user requests more information. The graph 900 includes the question at hand 901, a graphical representation of the percentages of peer companies who answered the question in various ways, and a legend showing the possible answers.

Region 106 links to the underlying regulation related to the current question. Regions 105 and 106 provide explanations regarding CMMC questions (e.g., information to assist the user to determine whether a certain response should be selected to meet the desired maturity level). Embodiments are also related to a narrative explanation that includes a hyperlink to external resources (such as https://www.acq.osd.mil/) that can be selected by the user such that the user is then directed to a source of the data.

The interview screen includes navigation buttons 107 (previous) and 108 (next) to allow the user to move through the interview screens.

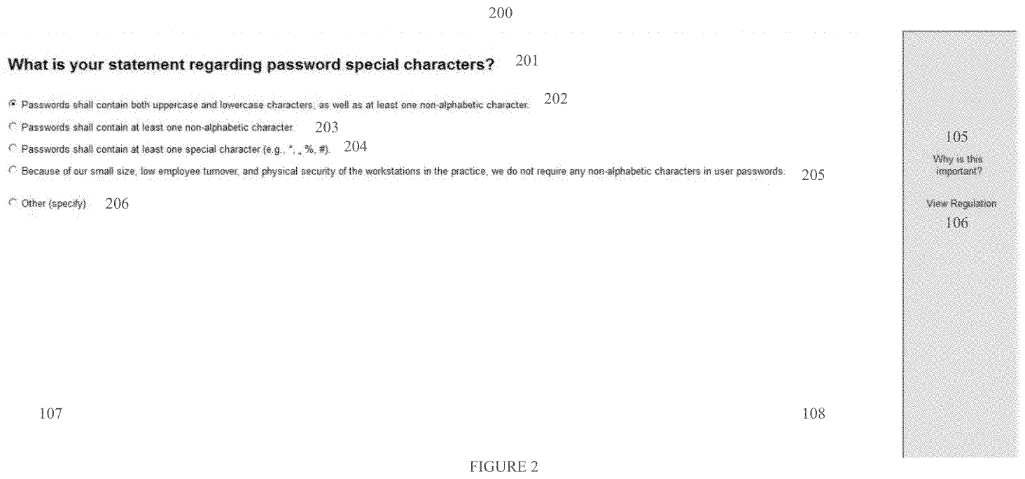

FIG. 2 illustrates a second example interview screen 200 in an embodiment of the system. The screen 200 includes a question region 200 and statements 202, 203, 204, and 205, along with a dialog box 206 to provide free-form information. Each interview screen 105 includes information regions 105 and 106 and navigation buttons 107 and 108.

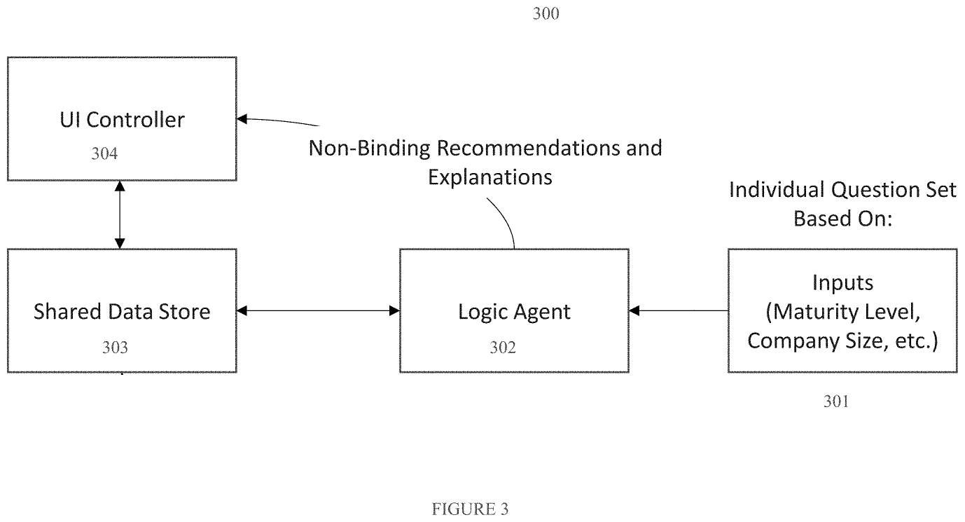

FIG. 3 is a block diagram of an embodiment of the system for receiving inputs. It illustrates an example of an embodiment of a computer-implemented method for preparing CMMC documentation for applicable CMMC maturity levels for a company in an “interview” mode involving interview screens (such as those of FIG. 1 or FIG. 2) related to a CMMC maturity level.

Input Module 301 receives information about the user (e.g., maturity level being sought, company size, and the like). This information is provided to the Logic Agent 302 which interacts with the Shared Data Store 303 to generate the interview screens that take the user through the process to determine maturity level.

The shared data store includes all of the rules and questions required of every maturity level of the CMMC. The appropriate rules and questions are determined by the Logic Agent 302 based on the inputs from 301. The UI Controller 304 then presents interview screens to a user by pulling information from the Shared Data Store 303 under the control of Logic Agent 302. The Logic Agent 302 also generates non-binding recommendations and explanations as part of the process.

When the user answers a question on an interview screen the UI controller writes the answer to the shared data store 303 and tracks the score of the user to determine if the desired maturity level is reached.

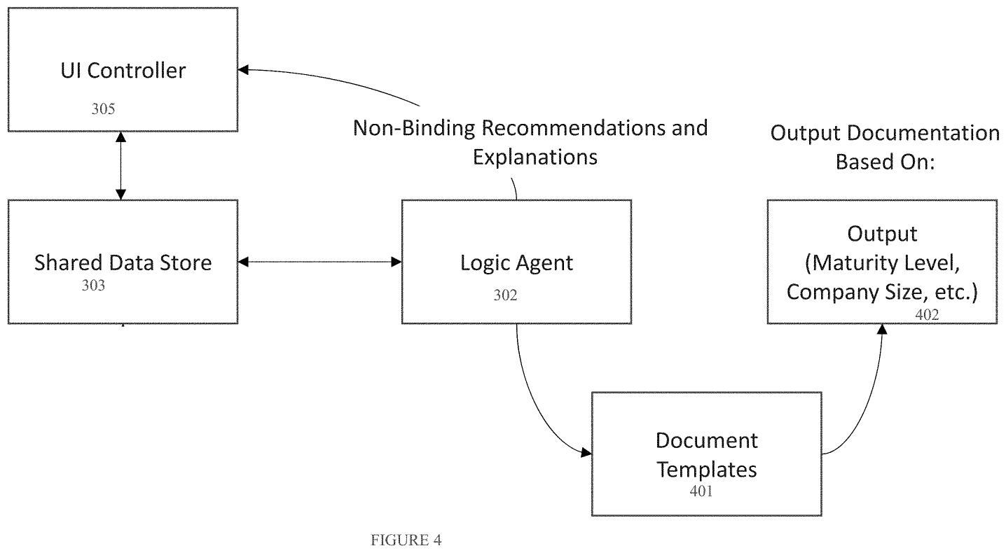

FIG. 4 illustrates an embodiment of the system related to development of electronic CMMC documentation tailored to the company based on the responses given, to include processes and practices. It also illustrates embodiments related to production of required documentation including processes and practices tailored to the individual company. In some cases, there is documentation required for CMMC accreditation, including processes and practices tailored to the individual company.

The Logic Agent 302 uses data from the Shared Data Store 303 and scores to build documents using Document Templates 401. The system then outputs the documentation via output 402 based on the maturity level, company size, and the like). The documents include policy and procedure documents, and other documentation needed for regulatory compliance. The system can populate the templates using information created by the user answering the questions in the interview screens.

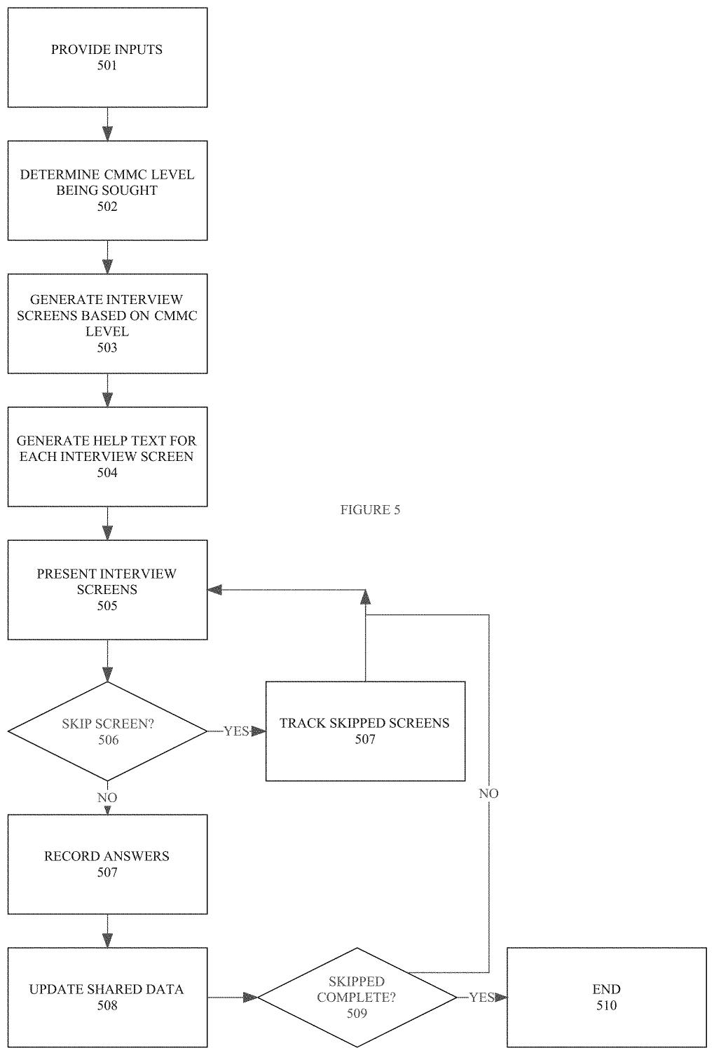

FIG. 5 is a flow diagram illustrating the operation of the system in an embodiment. At step 501, the user provides inputs to the system including maturity level desired, company size, resources, amount of risk level (e.g., amount and/or sensitivity of confidential information) and the like. At step 502 the CMMC level being sought is determined from the input data.

At step 503 the system generates interview screens based on the CMMC level. At step 504 the system generates the help text for each interview screen 504. At step 505 the interview screens are presented to the user. At decision block 506 it is determined if the user desires to skip a particular screen. If so, the system proceeds to step 507, tracks the skipped screen(s); and returns to step 505 to present the next screen.

If the user does not skip the screen at decision block 506, the system records the answer(s) provided by the user at step 507. The system then updates the Shared Data Store 303 at step 508 with the answers of the user.

At decision block 509 it is determined if the user has completed the previously skipped questions. If so, the system ends at step 510. If not, the system returns to step 505 and presents the next skipped screen for answering.

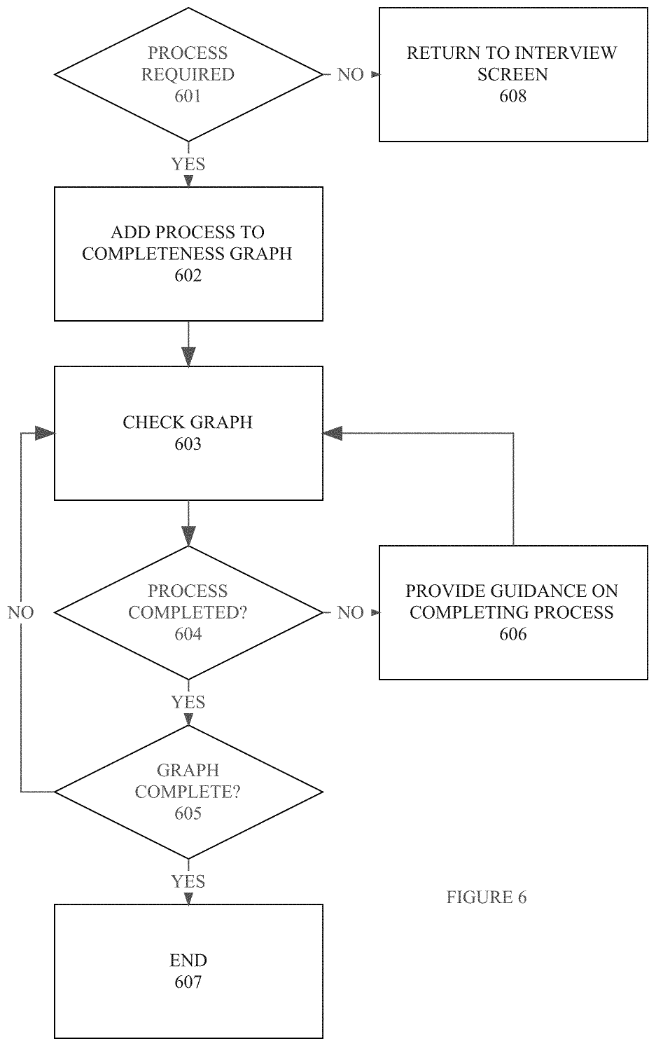

FIG. 6 illustrates an example of a system for embodiments related to a logic agent configured to determine that an active response to a question is required by analyzing the CMMC level required. At decision block 601 it is determined if a process is required to be completed to achieve the desired maturity level. For example, if the user has Controlled Unclassified Information (CUI) on mobile devices, a certain maturity level may require that such data be encrypted. If no, the system returns to the interview screen at step 608.

If a process is required, the system will add the process to a completeness graph at step 602. At step 603 the graph is checked. At decision block 604 it is determined if the required process has been completed. If not, the system will provide guidance for completing the process at step 606 and continue checking the completion graph at step 603.

If the process has been completed at step 604, the system checks to see if the graph is complete at decision block 605. If not, the system returns to step 603 to continue checking the graph. If so, the system ends at step 607.

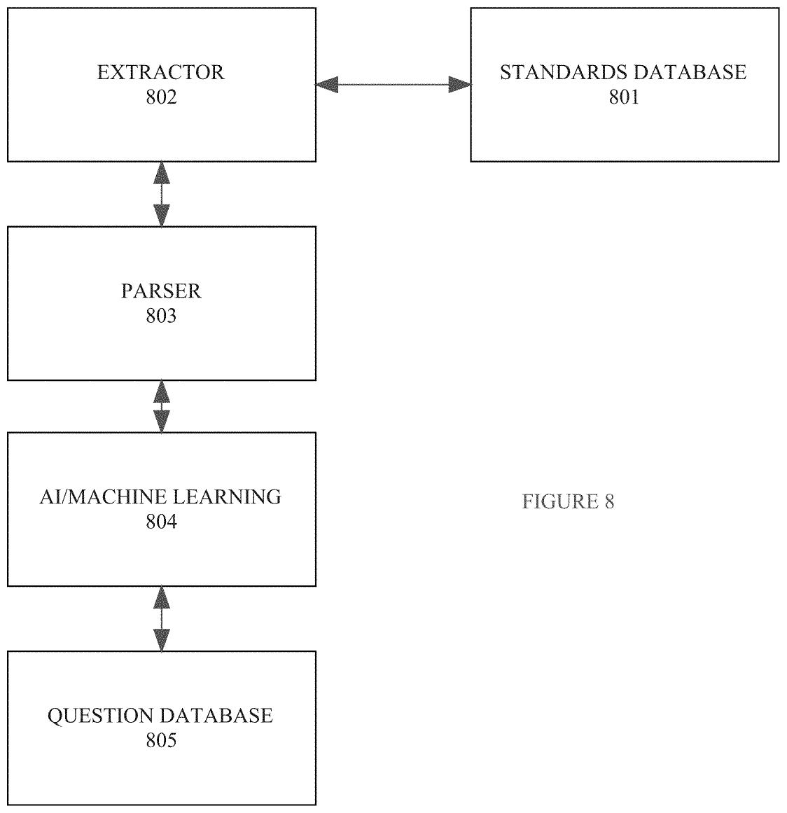

FIG. 8 is a block diagram illustrating the conversion of standards and regulations to close ended questions in an embodiment. A standards database 801 stores the rules and regulations associated with a standard. Extractor 802 gathers the data regarding the standard from the database 801. The extractor can then normalize the data and put it into a consistent form for further analysis and processing. Parser 803 is used to extract keywords from the data and to also associate metadata with the data (e.g., rule numbers, sublevels of outlines, and the like). The parsed data is provided to an Artificial Intelligence/Machine Learning module 804 where it is converted into questions with close ended answers. For example, if a network security standard defines different levels of password types, the module 804 will generate an interview screen with a question and with each level of password type offered as a close ended response to the question. The questions are then added to a Question Database 805. Eventually the questions are provided to the shared datastore 303.

The system may be implemented on a computing device. The computing device may be a remotely located computing device that is separate from another computing device that contains a user interface. For example, a user may run a browser or application on a mobile device such as a laptop, tablet, Smartphone, or the like which contains the user interface. A personal computer may also be used in this manner in which a remotely located computer is used to implement core functions of the program. A remotely located computing device may execute one or more modules of the system, for example, the logic agent and the user interface manager. Alternatively, software modules may be incorporated into a single computing device that includes the user interface aspect.

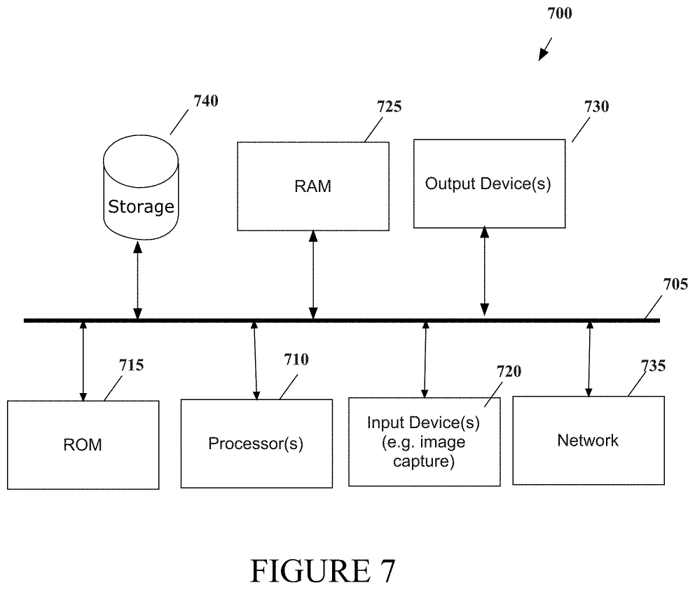

FIG. 7 illustrates an exemplary a system 700 that may implement the system. The electronic system 700 of some embodiments may be a mobile apparatus. The electronic system includes various types of machine-readable media and interfaces. The electronic system includes a bus 705, processor(s) 710, read only memory (ROM) 715, input device(s) 720, random access memory (RAM) 725, output device(s) 730, a network component 735, and a permanent storage device 740.

The bus 705 communicatively connects the internal devices and/or components of the electronic system. For instance, the bus 705 communicatively connects the processor(s) 710 with the ROM 715, the RAM 725, and the permanent storage 740. The processor(s) 710 retrieve instructions from the memory units to execute processes of the invention.

The processor(s) 710 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine-readable storage medium (also referred to as machine readable medium). When these instructions are executed by one or more of the processor(s) 710, they cause the processor(s) 710 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 710. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 700, define one or more specific machine implementations that execute and perform the operations of the software programs.

The ROM 715 stores static instructions needed by the processor(s) 710 and other components of the electronic system. The ROM may store the instructions necessary for the processor(s) 710 to execute the processes provided by the system. The permanent storage 740 is a non-volatile memory that stores instructions and data when the electronic system 700 is on or off. The permanent storage 740 is a read/write memory device, such as a hard disk or a flash drive, and it could be cloud based storage as well. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 725 is a volatile read/write memory. The RAM 725 stores instructions needed by the processor(s) 710 at runtime, the RAM 725 may also store the real-time video or still images acquired by the system. The bus 705 also connects input and output devices 720 and 730. The input devices enable the user to communicate information and select commands to the electronic system. The input devices 720 may be a keypad, image capture apparatus, or a touch screen display capable of receiving touch interactions. The output device(s) 730 display images generated by the electronic system. The output devices may include printers or display devices such as monitors.

The bus 705 also couples the electronic system to a network 735. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The example of FIG. 7 may also be implemented as a cloud-based system as desired.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, a system and method for implementing CMMC has been described.

What is claimed is:

1. A method of determining certification related to a standard comprising:
receiving from a user a desired level of compliance;
generating a series of interview screens each related to an aspect of compliance;
providing close ended responses with each interview screen for selection by the user;
determining if the user has achieved the desired level of compliance based on the responses selected by the user.

2. The method of claim 1, wherein explanations are provided to the user regarding the interview screens.

3. The method of claim 1, wherein the close ended responses incorporate industry standard practices.

4. The method of claim 1, wherein the user is provided with the capability to access and/or modify a response.

5. The method of claim 1, wherein the user is given the option to skip an interview screen without entering a response; and generating and storing, by a user interface manager, a skipped question record indicating that the question was skipped.

6. The method of claim 5, wherein the user is required to answer all skipped interview screens prior to determining the compliance level.

7. The method of claim 1, wherein a logic agent is configured to read data from a shared data store, evaluate missing data, and determine one or more suggested processes for obtaining the missing data.

8. The method of claim 1, wherein statistics and analytics relating to how peer organizations responded to interview screens is provided to the user in order to help the user choose industry standard security practices and thereby demonstrate regulatory compliance.

9. The method of claim 1 further including populating a document template with answers from the user and creating a document required for regulatory compliance.
